(19) United States
(12) Patent Application Publication
(10) Pub. No.: US 2014/0349690 A1
(43) Pub. Date: Nov. 27, 2014

(54) METHOD AND DEVICE FOR GENERATING CONTACT ENTRY, AND STORAGE MEDIUM

(71) Applicant: TENCENT TECHNOLOGY (SHENZHEN) COMPANY LIMITED, Guangdong (CN)

(72) Inventor: Liu YANG, Guangdong (CN)

(21) Appl. No.: 14/456,527

(22) Filed: Aug. 11, 2014

Related U.S. Application Data
(63) Continuation of application No. PCT/CN2014/073866, filed on Mar. 21, 2014.

(30) Foreign Application Priority Data
Mar. 29, 2013 (CN) 201310109312.1

(51) Int. Cl. H04W 4/14

(52) U.S. Cl. CPC H04W 4/14
USPC 455/466

(57) ABSTRACT

A method and a device for generating a contact entry are disclosed, and the method includes: receiving text information; extracting information of a contact person from the text information, where the information of the contact person includes contact name; establishing association between the contact name and contact information of the contact person, and generating a contact entry according to the association. The present disclosure solves the existing problem of complicated operations of the method for adding a contact entry in the prior art. As such, the contact name and the contact information of the contact person in the text information are bound by a more intelligent process of adding a contact entry, user's operations are simplified, system processing efficiency is increased, and user experience is improved.

### CROSS-REFERENCE TO RELATED APPLICATIONS

This patent application claims priority to and is a continuation application of PCT/CN2014/073866, filed on Mar. 21, 2014 and entitled “METHOD AND DEVICE FOR GENERATING CONTACT ENTRY, AND STORAGE MEDIUM”, which claims priority to Chinese Patent Application number 201310109312.1, entitled “METHOD AND DEVICE FOR GENERATING CONTACT ENTRY”, filed on Mar. 29, 2013 by TENCENT TECHNOLOGY (SHENZHEN) CO., LTD., the disclosures of which are incorporated herein by reference in their entireties.

### FIELD OF THE DISCLOSURE

The present disclosure relates to the field of communications, in particular, to a method and a device for generating a contact entry, and a storage medium.

### BACKGROUND

Currently, it is often that a mobile number in a short message in a mobile phone is added to a certain contact entry within a contact list as contact information of a contact person. In particular, when new contact information is received from a friend via a short message having content such as Hello, I am Xiaoming HUANG and my new mobile number is 13500000000, please keep it, a new contact entry shall be added in the contact list to store the contact information, where both the name Xiaoming HUANG and the mobile number 13500000000 are inputted to the contact entry. Or, when new contact information is received from a friend via a short message having content such as “ [symbol] , [symbol] , [symbol] [symbol] : 13500000000, [symbol] ”, a new contact entry shall be added in the contact list to store the contact information, where both the name “ [symbol] ” and the mobile number 13500000000 are inputted to the contact entry.

In the prior art, since numbers can be recognized intelligently, the above mobile number 13500000000 can be generated automatically to avoid manual inputting of the mobile number in adding the new contact entry on a device. However, the name of the contact person has to be input manually, especially the inputting of a Chinese name is always very tedious and cannot be completed by only one or two steps. For example, to input a Chinese name “ [symbol] ” having a Chinese pinyin of huang xiao ming on a device, it is firstly required to switch to a Chinese input method on the device, and then input the above Chinese pinyin in sequence by the Chinese input method, which is thus very tedious; moreover, if the device is a touch screen mobile phone, a misoperation on the touch screen might occur and increase the complexity of the whole inputting process. In addition, if the short message is received by a user when the user is very busy, the user may have no time to perform these tedious operations of adding the contact entry, as a result, the short message might be forgotten.

Therefore, the solution of adding a contact entry in the prior art is rather complicated for a user, and cannot meet user's demands for quick and easy operations. Therefore, there exists a need for an improvement on the existing solution.

### SUMMARY

The present disclosure provides a solution for generating a contact entry, to solve the problem of complicated operations in the method for adding a contact entry in the prior art.

In one aspect of the present disclosure, a method for generating a contact entry is provided, and the method includes: receiving text information; extracting information of a contact person from the text information, wherein the information of the contact person includes a contact name; establishing association between the contact name and contact information of the contact person; and generating a contact entry according to the association.

In another aspect of the present disclosure, a device for generating a contact entry is provided, and the device is provided in a mobile device or a user client and includes: a receiving module configured to receive text information; an extraction module configured to extract information of a contact person from the text information, wherein the information of the contact person includes a contact name; and a generation module configured to establish association between the contact name and contact information of the contact person, and generate a contact entry according to the association.

In still another aspect of the present disclosure, a storage medium storing computer executable instructions is provide, where the computer executable instructions are configured to, when executed by a computer processor, perform a method for generating a contact entry, the method includes: receiving text information; extracting information of a contact person from the text information, wherein the information of the contact person comprises a contact name; establishing association between the contact name and contact information of the contact person; and generating a contact entry according to the association.

According to the solutions of the present disclosure, the contact name is extracted from the received text information, the association between the contact name and the contact information of the contact person is established, and a contact entry is generated according to the association, to solve the existing problem of complicated operations of the method for adding a contact entry in the prior art. As such, the contact name and the contact information of the contact person in the text information are bound by a more intelligent process of adding a contact entry, user's operations are simplified, system processing efficiency is increased, and user experience is improved.

### BRIEF DESCRIPTION OF THE FIGURES

The attached drawings, which form a part of the present application, are intended to provide further explanation of the present disclosure. Exemplary embodiments of the present invention and illustration thereof are intended to explain the invention but not to improperly limit the disclosure. The drawings may be modified and substituted by those skilled in the art without any creative work, wherein

FIG. 1 is a flowchart of a method for generating a contact entry according to an embodiment of the present invention;

FIG. 2 is a structural block diagram of a device for a generating a contact entry according to an embodiment of the present invention;

FIG. 3 is a structural block diagram of a device for generating a contact entry according to another embodiment of the present invention;

FIG. 4 is a structural block diagram of a device for generating a contact entry according to still another embodiment of the present invention;

FIG. 5 is a schematic flowchart of a method for generating and quickly adding a contact entry according to still another embodiment of the present invention; and

FIG. 6 is a structural diagram of a mobile device according to an embodiment of the present invention.

### DETAILED DESCRIPTION

It should be noted that embodiments of the present invention and features therein can be combined with each other if no conflict arises. The present disclosure will be illustrated in detail with reference to the drawings and in conjunction with the embodiments in order to make objects, solutions and advantages of the present disclosure more apparent. The described particular embodiments are provided merely for explaining the disclosure, but not limiting the disclosure.

In the description below, various embodiment of the invention will be described with reference to symbol representation of actions and operations performed by one or more computers, unless otherwise stated. Thereby, it can be understood that such actions and operations sometimes performed by the computers include the manipulation of computer processing units conducted on an electrical signal that represents data in a structured form. Such manipulation transforms the data or maintains the data at a position in a computer storage system, which reconfigures or changes the operations of the computer in a manner understandable by those skilled in the art.

In an implementation, information of a contact person (such as a contact entry in a contact list) is often browsed, looked up and stored in a personal mobile device (such as, a mobile phone, a tablet computer, and a personal digital assistant (PDA)) and in the Internet environment (such as, emails and instant messaging).

In view of the complicated user operates of adding a contact entry in the prior art and the user's demands for quick and easy operations, the embodiments of the invention optimize the existing process of adding and storing information of a contact person, and provide a method for generating a contact entry under a principle of making a product with good user experience.

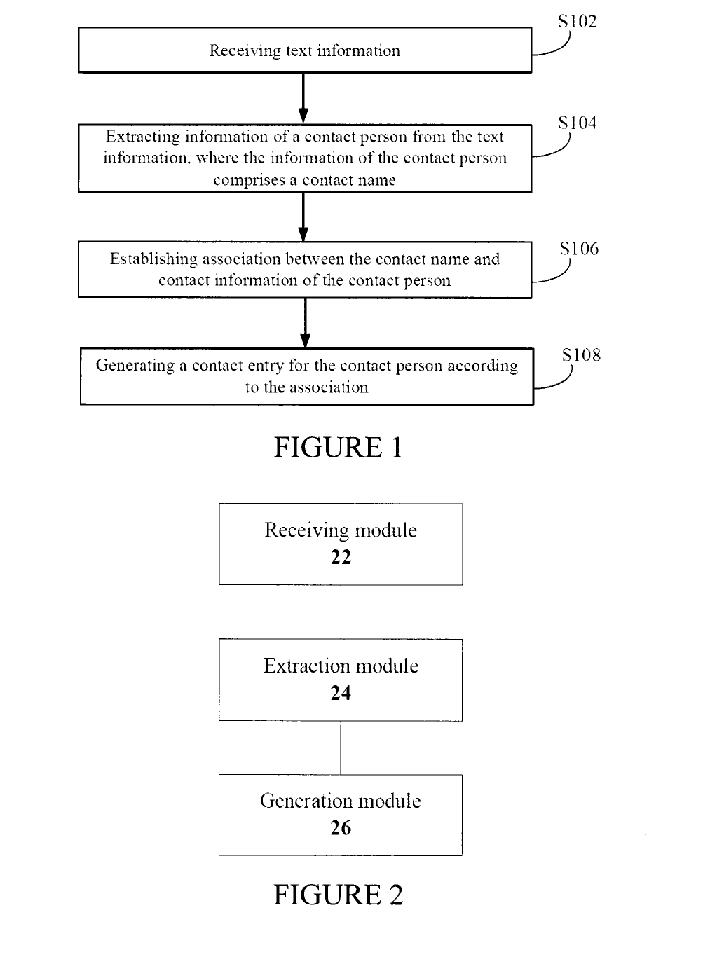

FIG. 1 is a flowchart of a method for a generating a contact entry according to an embodiment of the invention. As shown in FIG. 1, the method includes the follows steps S102, S104, S106, and S108.

In Step S102, text information is received.

In Step S104, information of a contact person is extracted from the received text information, where the information of the contact person at least includes a contact name.

In Step S106, association between the contact name and contact information of the contact person is established.

In Step S108, a contact entry is generated according to the association between the contact name and the contact information.

By the above steps, in the embodiments of the invention, the contact name is extracted from the received text information, the association between the contact name and the contact information of the contact person is established, and a contact entry is generated according to the association, to solve the existing problem of complicated operations of the method for adding a contact entry in the prior art. As such, the contact name and the contact information of the contact person in the text information are bound by a more intelligent process of adding a contact entry, user's operations are simplified, system processing efficiency is increased, and user experience is improved.

The principle of the embodiment of the invention is illustrated to be implemented in a suitable computer environment. The description below is based on the above embodiment of the invention, and the present disclosure should not be limited by alternative embodiments not explicitly described here.

For example, in Step S104, a position of a preset keyword may be determined from content of the received text information, and at least one character adjacent to the determined position of the preset keyword is extracted as the contact name according to the determined position of the preset keyword. The extracted contact name may be, for example, a real name of the contact person, a nickname of an account registered with a chat software (such as a username in an instant messaging software), or a name identifier or agname customized by the receiving user. Of course, the contact name can also be represented in English or other languages. The method of the present disclosure is widely applicable, not only to add a contact entry according to a telecommunication short message, but also to add a contact entry according to an instant messaging message in the Internet. In other words, the content of the text information in Step S102 may be from at least one of sources including: a short message, a multimedia message, an e-mail, a text file, an instant messaging message, and text content in a web page.

In the implementation of the method, at least one character adjacent to the determined position of the preset keyword may be extracted as the contact name according to the determined position of the preset keyword in the following two ways.

In a first way, if a type of the preset keyword, which depends on the content of the preset keyword, indicates a forward extraction, for example, if the preset keyword is any from a group including “ [symbol] ”, “ [symbol] ”, “ [symbol] ”, “ [symbol] ”, wish, hope, and happy new year to you, character(s) between a starting position and an ending position is extracted as the contact name, where the starting position is a position of a special character most closely preceding to the preset keyword, and the ending position is the determined position of the preset keyword. Herein, the special character may include at least one from a group of special characters including: a comma, a period, a semicolon, an ellipsis, a dash, a space, a wrap mark, a question mark, and the forefront of the text.

In a second way, if a type of the preset keyword, which depends on the content of the preset keyword, indicates a backward extraction, for example, if the preset keyword is from a group including “ [symbol] ”, “ [symbol] ”, “ [symbol] ”, I am, and My name is, character(s) between a starting position and an ending position is extracted as the contact name, where the starting position is the determined position of the preset keyword, and the ending position is a position of the first special character after the starting position. Herein, the special character may include at least one from a group of special characters including: a comma, a period, a semicolon, a dash, a space, and a wrap mark.

In an embodiment, a plurality pieces of information of the contact person (such as a number of names of the same contact person) are extracted from the content of the received text information, a user is prompted to confirm the extracted plurality pieces of information of the contact person and the association. In an implementation, the extracted information of the contact person may include one or more pieces of candidate information corresponding to preset field(s) in the contact entry. Of course, the received text information can also include several contact persons and contact information of each of the contact persons.

Illustratively in an example, a mobile device carried by a user named [symbol] receives a short message, the content of which is “ [symbol] , [symbol] 13566985623”. If the preset keywords for a contact name field in the mobile device include “ [symbol] ”, “ [symbol] [symbol] ”, “ [symbol] ” and “ [symbol] ”, the mobile device searches for the above preset keywords in the content of the short message after receiving the short message and finds a preset keyword “ [symbol] ”, and then determines that the type of the preset keyword “ [symbol] ” indicates the backward extraction, in this case, character(s) between a starting position which is the position of the preset keyword “ [symbol] ” and an ending position which is a position of the first special character (such as a comma) after the preset keyword “ [symbol] ” is extracted as the contact name, which is “ [symbol] ” in this example.

Illustratively in an example, a mobile device carried by a user named Xiaoming receives a short message, the content of which is I am Xiaowang and my new mobile number is 13566985623. If the preset keywords for a contact name field in the mobile device include wish, happy New Year to you, my name is and I am, the mobile device searches for the above preset keywords in the content of the short message after receiving the short message and finds a preset keyword I am, and then determines that the type of the preset keyword I am indicates the backward extraction, in this case, character(s) between a starting position which is the position of the preset keyword I am and an ending position which is a position of the first special character (such as a comma) after the preset keyword I am is extracted as the contact name, which is Xiaowang in this example.

To prompt a user to confirm the extracted plurality pieces of information of the contact person, it is possible to sequentially prompt the user to confirm the extracted plurality pieces of information of the contact person according to a preset order in which the plurality pieces of information of the contact person are arranged in the contact entry. Such method further improves the precision of the added information.

For example, information of a contact person in the contact entry includes fields such as contact name, mobile number, chat account, and email address. In an implementation, the user is sequentially prompted to confirm the content of the respective extracted fields in an order of the above fields as listed. Here, the content of the text information is My name is Xiaomeng ZHOU, my mobile number is 13588721222 and may Fetion account number is 89456423, the preset keywords for the contact name field include My name is and I am, the preset keywords for the mobile number field include mobile phone and mobile number, the preset keywords for the chat account field include Fetion account number and Micro-blog account number, and the preset keyword for the email address field is email address. In this case, corresponding information is extracted from the content of the text information according to the keywords corresponding to the respective fields in the contact entry, and the information of the contact person is confirmed starting from contact name field. For example, the user is prompted to confirm Xiaomeng ZHOU, which is taken as a candidate for the contact name field, as the contact name, then the user is prompted to confirm 13588721222, which is taken as a candidate for the mobile number field, as the mobile number, and then the user is prompt to confirm 89456423, which is taken as a candidate for the chat account field, as the chat account. However, since content corresponding to the email address field is not found in the text information, the user may be prompted to edit the content of the email address field or otherwise not prompted. In an implementation, all the candidates for the fields in the contact entry may be listed in a form and then the user is prompted to confirm the candidates.

For example, information of a contact person in the contact entry includes fields such as contact name, mobile number, chat account, and email address. In another implementation, the user is sequentially prompted to confirm the content of the respective extracted fields in an order of the above fields as listed. Here, the content of the text information is “ [symbol] , [symbol] 13588721222, [symbol] 89456423”, the preset keywords for the contact name field include “ [symbol] ” and “ [symbol] ”, the preset keywords for the mobile number field include “ [symbol] ” and “ [symbol] ”, the preset keywords for the chat account field include “ [symbol] ” and “ [symbol] ”, and the preset keyword for the email address field is “ [symbol] ”. In this case, corresponding information is extracted from the content of the text information according to the keywords corresponding to the respective fields in the contact entry, and the information of the contact person is confirmed starting from contact name field. For example, the user is prompted to confirm “ [symbol] ” and “ [symbol] ” (with a space prefixed), which are taken as candidates for the contact name field, as the contact name, then the user is prompted to confirm 13588721222, which is taken as a candidate for the mobile number field, as the mobile number, and then the user is prompt to confirm 89456423, which is taken as a candidate for the chat account field, as the chat account. However, since content corresponding to the email address field is not found in the text information, the user may be prompted to edit the content of the email address field or otherwise not prompted. In an implementation, all the candidates for the fields in the contact entry may be listed in a form and then the user is prompted to confirm the candidates.

In addition, when the user is prompted to confirm the extracted information of the contact person and the association, the user may modify the extracted information of the contact person and the association. In other words, if confirming that a correct candidate for the information of the contact person does not exist, the user can modify the information of the contact person. For example, if the contact name in the text information is incorrect, the contact name can be modified during the confirmation.

In an implementation, in Step S104, according to a sending number of the received text information, a contact name from an existing contact entry and corresponding to the sending number is identified, and the contact name from the existing contact entry and corresponding to the sending number is determined as the contact name extracted from the text information. For example, if a piece of information with content of My mobile number is updated as 13455563317 is received from a contact person named Bo WANG existing in the contact list, although content of the received information does not contain a contact name, it is still possible to identify the source (i.e. sender) of the received information based on the received information. For example, if the source of the received information is represented by a telephone number, then a contact name in an existing contact entry which corresponds to the telephone number of the source can be identified according to the telephone number of the source, so that the identified contact name may be determined as a contact name extracted from the received information, and the contact information of the contact person extracted from the content of the received information is associated with the contact name, thus the contact entry is changed and updated in the contact list.

In an implementation, contact information of a contact person is obtained from the sending number of the received text information before Step S106. For example, the mobile number of a sender of a received short message may be obtained as the contact information (such as, a mobile number) in the contact entry. Typically, a short message contains a mobile number (which is generally a series of numbers) of the message sender and the message content, the mobile number may be taken as the contact information of the contact person, but the contact name in the contact entry is extracted from the content of the short message.

In Step S108, a contact entry may be generated based on the established association between the contact name and the contact information of the contact person in the following two ways: in a first way, information of the contact person is added to the existing contact entry according to the association; while in a second way, information of the contact person is added to a new contact entry newly created in the contact list according to the association. The method described above is simple and applicable, and is easy to operate.

For example, the above first way is generally adopted in a case where the contact name in the contact entry is not changed but the contact information of the contact person in the contact entry is changed. In this case, when a new short message with content my new mobile number is 13566325878 is received from a contact person named Xiao WANG who is listed in an existing contact entry, the mobile number from the content of the short message (i.e. the contact information of the contact person) is used as the new contact information of the contact person in the existing contact entry according to the method provided in the embodiments above. Or, when a new short message with content “ [symbol] [symbol] 13566325878” is received from a contact person named “ [symbol] ” who is listed in an existing contact entry, the mobile number from the content of the short message (i.e. the contact information of the contact person) is used as the new contact information of the contact person in the existing contact entry according to the method provided in the embodiments above. During such operation, the user may be prompted whether to replace the contact information of the existing contact person or add new contact information. As such, the association between the contact person and his/her new contact information is established, and the contact entry of the contact person is updated accordingly.

In an implementation, Step S104 is performed after a user command to add information of the contact person is received, so that the process of creating a contact entry is triggered by the user command, to make the operation more effective.

In an implementation, the information of the contact person at Step S104 includes contact information, which may include at least one from a group of fields including: a mobile number, a fixed telephone number, a chat account, a residential address, an email address, an employer and a group name. Each field of the contact information may correspond to more than one preset keyword, so that one or more candidates corresponding to each field may be extracted from the received text information by a fuzzy search method based on keywords. Such method is simple and applicable.

It should be noted that any step illustrated in the flowchart as shown in the drawings can be performed by a computer system through a group of computer-executable instructions. Although a logical order is illustrated in the flowchart, the illustrated or described steps may be performed in an order different from that as described herein.

Corresponding to the above method, an embodiment of the invention further provides a device for generating a contact entry. FIG. 2 is a structural block diagram of a device for generating a contact entry according to an embodiment of the invention. The structure as shown is only an example of suitable environment for the sake of description, and does not limit the range or function of the invention in any way. As shown in FIG. 2, the device 20 is provided in a mobile device or a user client and includes: a receiving module 22 configured to receive text information; an extraction module 24 coupled to the receiving module 22 and configured to extract information of a contact person from the received text information, where the information of the contact person includes a contact name; and a generation module 26 coupled to the extraction module 24 and configured to establish association between the contact name and contact information of the contact person, and generate a contact entry according to the association.

With the above device, the extraction module 24 extracts the contact name from the text information received by the receiving module 22, the generation module 26 establishes the association between the contact name and the contact information of the contact person, and generates the contact entry according to the association, thereby solving the problem of complicated operations of the method for adding a contact entry in the prior art. As such, the contact name and the contact information of the contact person in the text information are bound by a more intelligent process of adding a contact entry, user's operations are simplified, system processing efficiency is increased, and user experience is improved.

It should be noted that the above-described device 20 for generating a contact entry may be a certain module in a mobile device, an application or process in the mobile device, or a software in the mobile device. Of course, the device 20 for generating a contact entry may be configured on a user client, in this case, after the user client is started, the above function of generating a contact entry may be utilized when text information is received by a user surfing in the Internet or using other applications.

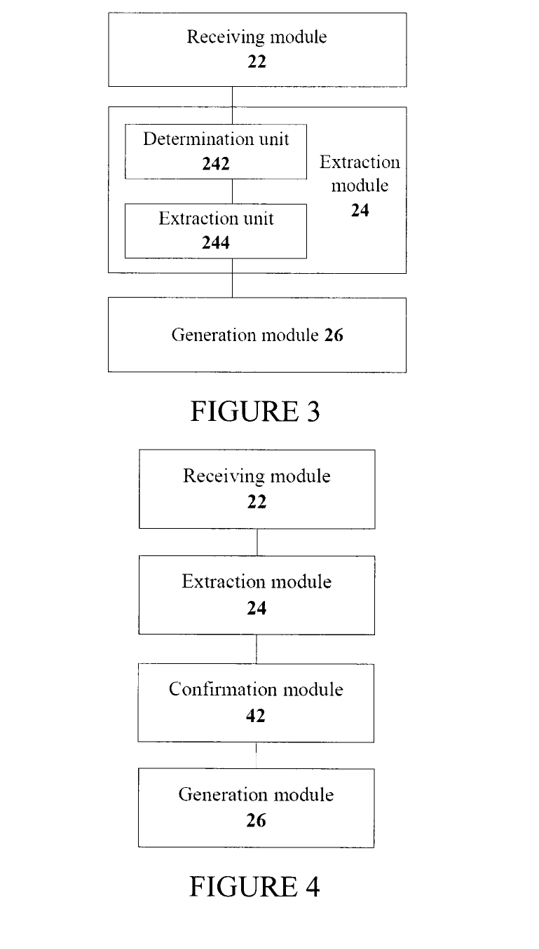

FIG. 3 is a structural block diagram of a device for generating a contact entry according to an embodiment of the invention. As shown in FIG. 3, the extraction module 24 includes: a determination unit 242 configured to determine a position of a preset keyword within the content of the text information received by the receiving module 22; and an extraction unit 244 coupled to the determination unit 242 and configured to extract at least one character adjacent to the determined position of the preset keyword as the contact name according to the determined position of the preset keyword.

For example, the extraction unit 244 may extract at least one character adjacent to the determined position of the preset keyword as the contact name according to the position of the preset keyword in two ways, i.e. a way of forward extraction and a way of backward extraction. If a type of the preset keyword indicates the forward extraction, for example, character(s) between a starting position and an ending position is extracted as the contact name, where the starting position is a position of a special character most closely preceding to the preset keyword, and the ending position is the determined position of the preset keyword. Herein, the special character may include at least one from a group of special characters including: a comma, a period, a semicolon, an ellipsis, a dash, a space, a wrap mark, a question mark, the forefront of the text. If a type of the preset keyword indicates the backward extraction, character(s) between a starting position and an ending position is extracted as the contact name, where the starting position is the determined position of the preset keyword, and the ending position is a position of the first special character after the starting position. Herein, the special character may include at least one from a group of special characters including: a comma, a period, a semicolon, a dash, a space, and a wrap mark. In an implementation, the determination unit 242 may be further configured to determine the type of the preset keyword, i.e. the forward extraction or the backward extraction.

FIG. 4 is a structural block diagram of a device for generating a contact entry according to another embodiment of the invention. As shown in FIG. 4, the device 20 further includes a confirmation module 42 configured to prompt a user to confirm a plurality pieces of information of the contact person and the association after the extraction module 24 extracts the plurality pieces of information of the contact person from the content of the text information.

Further, the confirmation module 42 is further configured to sequentially prompt the user to confirm the extracted plurality pieces of information of the contact person according to a preset order in which the plurality pieces of information of the contact person are arranged in the contact entry.

In an implementation, the confirmation module 42 may be further configured to prompt the user to modify the extracted information of the contact person and the association.

Exemplarily, the extraction module 24 is further configured to identify, according to a sending number of the received text information, a contact name from an existing contact entry and corresponding to the sending number, and determine the contact name from the existing contact entry and corresponding to the sending number as the contact name extracted from the text information.

Exemplarily, the extraction module 24 is further configured to obtain the contact information of the contact person from a sending number of the text information received by the receiving module 22. For example, if a user named Xiaoming receives a short message from another user having a mobile number 13588561221, then the mobile number 13588561221 is shown at the position of the sender number of the short message, here the content of the short message reads I am Yang LIU and this is my new mobile number. In this case, the contact information of the contact person may be directly extracted from the position of the sender number of the short message, and characters Yang LIU may be extracted from the content of the short message as a contact name to be confirmed by the user Xiaoming; and if the extracted information is incorrect, then the information being confirmed may be modified.

In addition, if the information of a contact person in a contact entry from a predetermined contact list further include fields such as a chat account and an email address in addition to the fields of the contact name and the mobile number, but only the fields of the contact call and the mobile number are contained in the content of the short message, then, when the confirmation module 42 prompts the user to confirm the information of the contact person extracted from the text information, the fields of the contact entry which are not present in the content of the short message are shown in an editable state, that is, shown as empty (writable) by default. In an implementation, the fields of the contact entry and the corresponding content extracted from the text information are shown in a form, to be confirmed by a user.

In an implementation, the generation module 26 generates the contact entry according to the association in such a way that the information of the contact person is added into an existing contact entry according to the association or that the information of the contact person is added into a new contact entry newly created in the contact list according to the association. That is, the former way allows to modify the information of the contact person in the existing contact entry, and the latter way allows to create a new contact entry.

For example, if a contact person named Bo HUANG is already recorded in an existing contact entry in the contact list, and a short message informing a change of contact information is received from Bo HUANG, then it should be confirmed whether to modify the existing contact entry for Bo HUANG (in the case that the contact person named Bo HUANG already recorded in an existing contact entry is the same as the contact person Bo HUANG sending the short message) or create a new contact entry (in the case that different contact persons share the same name) before the function of generating a contact entry is initiated. If it is selected to modify the existing contact entry, then after the extraction module 24 extracts the information of the contact person from the text information of the short message, the generation module 26 adds the information of the contact person into the existing contact entry according to the association between the contact name and contact information of the contact person; and if it is selected to create a new contact entry, then after the extraction module 24 extracts the information of the contact person from the text information of the short message, the generation module 26 adds the information of the contact person into a new contact entry newly created in the contact list according to the association between the contact name and contact information of the contact person.

The method of generating a contact entry using the above device 20 for generating a contact entry may include the following steps 1, 2 and 3.

In Step 1, the receiving module 22 receives text information from a sender, where the text information may be a short message, an email or an instant messaging message, etc.

In Step 2, the extraction module 24 extracts information of a contact person (i.e. the sender) from the text information received by the receiving module 22, where the information of the contact person includes but is not limited to a contact name which may be a real name or a nickname.

In Step 3, the generation module 26 establishes association between the contact name and contact information of the contact person, and generates a contact entry according to the association.

Exemplarily, in the case that the above-described device 20 for generating a contact entry further includes a confirmation module 42, the method further includes that: after the extraction module 24 extracts a plurality pieces of information of the contact person from the content of the text information, the confirmation module 42 prompts the user to confirm the extracted plurality pieces of information of the contact person and the association.

Further, the method may include that: the determination unit 242 in the extraction module 24 determine the position of a preset keyword within the content of the text information received by the receiving module 22; and then the extraction unit 244 in the extraction module 24 extracts at least one character adjacent to the determined position of the preset keyword as the contact name according to the determined position of the preset keyword.

The invention can be embodied using other general-purpose or dedicated computation or communication environment or configuration. Examples of the well-known computation systems, environment and configuration suitable for the invention include, but are not limited to a personal computer, a server, a multi-processor system, a microprocessor-based system, a minicomputer, a large computer and distributed computation environment including any of the above systems or devices.

It should be noted that terms “module”, “component” or “unit” as used in the embodiment of the invention may refer to an object or process (operated as a separate thread, for example) performed in a mobile device or Internet environment.

Further embodiments of the invention are illustrated in connection with the drawings below, and it is understood that the described embodiments are only used for illustrating and explaining the invention, but not for limiting the invention.

In an embodiment, for the convenience of user operations, a method for generating a contact entry is provided, to simplify the process of generating a contact entry in the prior art, and further optimize the existing complex and tedious process of adding a contact entry in the prior art.

In particular, firstly, text information is received, for example through an email via a mobile device or the Internet, an instant messaging message, etc.; subsequently information corresponding to any contact entry field (which may be preset) in the contact list (such as, a contact book) is extracted from the received text information by means of a keyword-based retrieval technology, where, the contact entry fields include a contact call field and a contact information field; then a user is prompted to confirm the extracted information corresponding to the contact entry field; and finally, a contact entry is generated according to the confirmed information and the generated contact entry is added to the contact list.

In an implementation, the function of adding a contact entry may be initiated after a user command to add the contact entry is received, to extract information corresponding to the field of the contact entry from the text information by means of the keyword-based retrieval technology.

It should be noted that the contact name in the contact entry may be a name, a nickname or an agname. For example, if the received text information is an instant messaging message in a chat application, then the contact name may be a nickname or a chat account; and if the received text information is content of an mail, then the contact name may be a name or an occupation.

In an implementation, by extracting information corresponding to the contact entry field from the received text information by means of the keyword-based retrieval technology, for example, it is possible to extract a contact name from the text information according to preset keywords (such as, “ [symbol] ”, “ [symbol] ”, My name is, and I am) for the contact name using a keyword-based fuzzy match method.

In an implementation, when the user is prompted to confirm the extracted information corresponding to the field of the contact entry, a plurality pieces of information may be extracted from the text information as candidates and the user is prompted to confirm the candidates, where any field of the contact entry may correspond to one or more of the candidates, thereby improving the system processing accuracy and efficiency.

Moreover, when the user is prompted to confirm the extracted information corresponding to the field of the contact entry, if all the candidates are incorrect, then the user is allowed to modify the content corresponding to the field of the contact entry to ensure its accuracy; or if the text information does not contain any content corresponding to the field of the contact entry, the user is allowed to manually input the content of the field.

In another embodiment, the method for automatically generating and quickly adding a contact entry by means of a keyword-based retrieval technology is illustrated by an example in which the method is applied in a mobile device.

In the mobile device, if a short message, content of which is Hello, I am Xiaoming HUANG and my new mobile number is 13500000000, please keep it, is received, as can be seen, the short message includes information of a contact entry, i.e. information of a contact person in the contact entry. According to the method provided by the embodiment, some information in the short message may be extracted intelligently by means of the keyword-based retrieval technology to generate a contact entry including a contact name of Xiaoming HUANG and a mobile number of 13500000000. Again, if a short message, content of which is “ [symbol] , [symbol] , [symbol] : 13500000000, [symbol] ”, is received, as can be seen, the short message includes information of a contact entry, i.e. information of a contact person in the contact entry. According to the method provided by the embodiment, some information in the short message may be extracted intelligently by means of the keyword-based retrieval technology to generate a contact entry including a contact name of “ [symbol] ” and a mobile number of 13500000000. That is in the embodiment, the user is merely required to confirm whether to add the contact entry, and once the addition of the contact entry is confirmed, the generated contact entry is easily added into the contact list of the user to save the steps of inputting the name of the contact person into the contact entry, thereby simplifying the process of creating and updating the contact entry.

With the method for automatically extracting a mobile number from the short message, the extracted mobile number and the name are associated and provided to the user, to enable the user to merely click a determination button to add the generated contact entry into the contact list.

In practice, it is not easy to precisely extract a name from a short message. In particular, with the function of keyword searching, a keyword may be matched by the fuzzy match, for example, for the content I am Xiaoming HUANG, the characters Xiaoming HUANG following the preset keyword I am (like preset keywords My name is, I myself etc.) are regarded as a candidate of the name of the contact entry; or, for the content “ [symbol] [symbol] ”, the characters “ [symbol] ” following the preset keyword “ [symbol] ” (like preset keywords “ [symbol] ”, “ [symbol] ”, etc.) are regarded as a candidate of the name of the contact entry. Of course, the result of such keyword searching (i.e. the result of the extraction) might be incorrect but may be corrected by the user, furthermore, the result of the recognition algorithm used in the embodiment may include several candidate names, so that the user may confirm and select a desired name as will in this case.

For example, in the case of a message with content including I am Xiao ming my new mobile number is 13500000000, in which there is no separator following the name (i.e. the contact name), then two or three words following the preset keyword I am may be extracted as a candidate of the name, to generate two candidate options of: 1) Xiao ming 13500000000; and 2) Xiao ming my: 13500000000. Facing such two options provided to the user, the user can easily select the former as a contact entry. Again, in the case of a message with content including “ [symbol] 13500000000”, in which there is no separator following the name (i.e. the contact name), then two or three characters following the preset keyword “ [symbol] ” may be extracted as a candidate of the name, to generate two candidate options of: 1) [symbol] : 13500000000; and 2) [symbol] : 13500000000. Facing such two options provided to the user, the user can easily select the former as a contact entry.

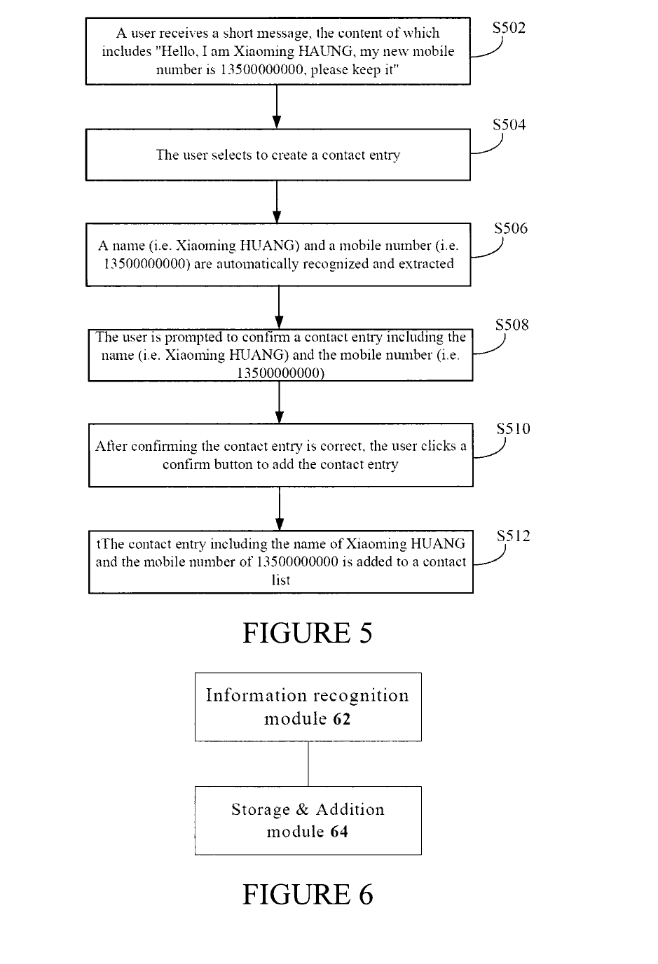

FIG. 5 is a flow diagram of a method for generating a contact entry and quickly adding the contact entry according to another embodiment of the invention. As shown in FIG. 5, the flow includes the following steps S502, S504, S506, S508, S510, and S512.

In Step S502, a user receives a short message, the content of which includes Hello, I am Xiaoming HAUNG, my new mobile number is 13500000000, please keep it.

In Step S504, the user selects to create a contact entry.

In Step S506, a name (i.e. Xiaoming HUANG) and a mobile number (i.e. 13500000000) are automatically recognized and extracted.

In Step S508, the user is prompted to confirm a contact entry including the name (i.e. Xiaoming HUANG) and the mobile number (i.e. 13500000000).

In Step S510, after confirming the contact entry is correct, the user clicks a confirm button to add the contact entry.

In Step S512, the contact entry including the name of Xiaoming HUANG and the mobile number of 13500000000 is added to a contact list.

In the embodiment, the method for automatically generating and quickly adding a contact entry by means of keyword-based retrieval technology advantageously reduces the steps of adding a contact entry from the original 10˜20 steps to 2˜3 steps, to significantly simply the user operation steps, so that the process of adding a contact entry by the user is no longer tedious, and the user experience is improved. Further, any misoperation might be caused in the existing complicated operations can be avoided, thus offering the user with quick and easy experience.

It should be noted that any step illustrated in the flowchart as shown in the drawings can be performed in a computer system through for example a group of computer-executable instructions. Although a logical order is illustrated in the flowchart, the illustrated or described steps may be performed in an order different from that as described herein.

In the present embodiment, simpler operations of adding a contact entry is provided for the user, the existing manual operations to be performed by the user are intelligently completed without efforts from the user, to make the resultant product easy to use and optimize the flow of adding a contact entry in the prior art.

An embodiment further provides a computer program configured to perform the above-described method and a storage medium storing the computer program. Thus, the above embodiments enable an operation process conforming to nature rules by a suitable computer architecture.

Namely, an embodiment of the preset invention provides a storage medium storing computer executable instructions which may be executed by a computer processor to perform a method for generating a contact entry, and the method includes:

receiving text information;

extracting information of a contact person from the received text information, where the information of the contact person includes a contact name;

establishing association between the contact name and contact information of the contact person; and

generating a contact entry according to the association.

Still another embodiment provides a mobile device. FIG. 6 is a structural diagram of a mobile device according to still another embodiment of the invention. As shown in FIG. 6, the mobile device includes: an information recognition module 62 configured to extract information of a contact person from the received text information, where the information of the contact person includes a contact name; and a storage and addition module 64 coupled to the information recognition module 62 and configured to store the information of the contact person and obtained contact information of the contact person, and add the information of the contact person and obtained contact information of the contact person to a contact list.

In the mobile device, the steps of adding the contact entry are reduced to obtain an easy process of adding the contact name such as the name of the contact person, namely, there is no need to input the contact name manually, so that any misoperation that might be caused by the user when performing the existing complicated process of adding the contact entry is avoided, thereby improving the user experience.

As can be seen from the above, in the embodiments of the invention, the contact name is extracted from the received text information, the association between the contact name and the contact information of the contact person is established, and a contact entry is generated according to the association, to solve the existing problem of complicated operations of the method for adding a contact entry in the prior art. As such, the contact name and the contact information of the contact person in the text information are bound by a more intelligent process of adding a contact entry, user's operations are simplified, system processing efficiency is increased, and user experience is improved.

Obviously, it would be appreciated by those skilled in the art that various modules or steps in the above invention can be implemented by a general purpose computing device, and these modules or steps can be concentrated on a single computing device or distributed in a network formed by a plurality of computing devices. Optionally, these modules or steps can be implemented by program codes executable by the computing device, so that these modules or steps can be stored in storage means and performed by the computing device, or implemented as various integrated circuit modules, or some of the modules or steps can be embodied as a single integrated circuit. In this way, the invention is not limited to any combination of particular hardware and software.

The embodiments of the present invention have been described as above, but are not intended to limit the scope of the invention. Various alterations and changes of the invention may readily occur to those skilled in the art. Any modifications, equivalent substitutions, improvements, etc. that are made without departing from the scope and principle of the invention fall in the scope of the invention.

1. A method for generating a contact entry, comprising:
receiving text information;
extracting information of a contact person from the text information, wherein the information of the contact person comprises a contact name;
establishing association between the contact name and contact information of the contact person; and
generating a contact entry for the contact person according to the association.

2. The method of claim 1, wherein extracting information of a contact person from the text information comprises:
determining a position of a preset keyword within content of the text information; and
extracting at least one character adjacent to the determined position of the preset keyword as the contact name.

3. The method of claim 2, wherein extracting at least one character adjacent to the determined position of the preset keyword as the contact name comprises:
if a type of the preset keyword indicates a forward extraction, extracting characters between a starting position and an ending position as the contact name, wherein the starting position is a position of a special character most closely preceding to the preset keyword, and the ending position is the determined position of the preset keyword.

4. The method of claim 2, wherein extracting at least one character adjacent to the determined position of the preset keyword as the contact name comprises:
if a type of the preset keyword indicates a backward extraction, extracting characters between a starting position and an ending position as the contact name, wherein the starting position is the determined position of the preset keyword, and the ending position is a position of the first special character after the starting position.

5. The method of claim 1, wherein extracting information of a contact person from the text information comprises: extracting a plurality pieces of information of the contact person from content of the text information; and
establishing association between the contact name and contact information of the contact person comprises: prompting a user to confirm the plurality pieces of extracted information of the contact person and the association.

6. The method of claim 2, wherein extracting information of a contact person from the text information comprises: extracting a plurality pieces of information of the contact person from content of the text information; and
establishing association between the contact name and contact information of the contact person comprises: prompting a user to confirm the plurality pieces of extracted information of the contact person and the association.

7. The method of claim 3, wherein extracting information of a contact person from the text information comprises: extracting a plurality pieces of information of the contact person from content of the text information; and
establishing association between the contact name and contact information of the contact person comprises: prompting a user to confirm the plurality pieces of extracted information of the contact person and the association.

8. The method of claim 4, wherein extracting information of a contact person from the text information comprises: extracting a plurality pieces of information of the contact person from content of the text information; and
establishing association between the contact name and contact information of the contact person comprises: prompting a user to confirm the plurality pieces of extracted information of the contact person and the association.

9. The method of claim 5, wherein prompting a user to confirm the extracted plurality pieces of information of the contact person and the association comprises:
sequentially prompting the user to confirm the extracted plurality pieces of information of the contact person according to a preset order in which the plurality pieces of information of the contact person are arranged in the contact entry.

10. The method of claim 1, wherein extracting information of a contact person from the text information further comprises:
identifying, according to a sending number of the received text information, a contact name from an existing contact entry and corresponding to the sending number; and
determining the contact name from the existing contact entry and corresponding to the sending number as the contact name extracted from the text information.

11. The method of claim 1, before establishing association between the contact name and contact information of the contact person, further comprising:
obtaining the contact information of the contact person from a sending number of the received context information.

12. The method of claim 1, wherein generating a contact entry for the contact person according to the association comprises:
adding the information of the contact person into an existing contact entry according to the association; or
adding the information of the contact person into a contact entry newly created in a contact list according to the association.

13. A device for generating a contact entry, where in the device is provided in a mobile device or a user client and comprises:
a receiving module configured to receive text information;
an extraction module configured to extract information of a contact person from the text information, wherein the information of the contact person comprises a contact name; and
a generation module configured to establish association between the contact name and contact information of the contact person, and generate a contact entry according to the association.

14. The device of claim 13, wherein the extraction module comprises:
a determination unit configured to determine a position of a preset keyword within content of the text information; and
an extraction unit configured to extract at least one character adjacent to the determined position of the preset keyword as the contact name according to the determined position of the preset keyword.

15. The device of claim 13, further comprising:
a confirmation module configured to prompt a user to confirm a plurality pieces of extracted information of the contact person and the association after the extraction module extracts the plurality pieces of information of the contact person from the content of the text information.

16. The device of claim 13, wherein the extraction module is further configured to identify, according to a sending number of the received text information, a contact name from an existing contact entry and corresponding to the sending number, and determine the contact name from the existing contact entry and corresponding to the sending number as the contact name extracted from the text information.

17. The device of claim 13, wherein the extraction module is further configured to obtain the contact information of the contact person from a sending number of the text information received by the receiving module.

18. The device of claim 13, wherein the generation module is further configured to add the information of the contact person into an existing contact entry according to the association, or add the information of the contact person into a contact entry newly created in a contact list according to the association.

19. The device of claim 14, wherein the generation module is further configured to add the information of the contact person into an existing contact entry according to the association, or add the information of the contact person into a contact entry newly created in a contact list according to the association.

20. A storage medium storing computer executable instructions, wherein the computer executable instructions are configured to, when executed by a computer processor, perform a method for generating a contact entry, and the method comprises:
receiving text information;
extracting information of a contact person from the text information, wherein the information of the contact person comprises a contact name;
establishing association between the contact name and contact information of the contact person; and
generating a contact entry according to the association.
